(19) United States
(12) Patent Application Publication
(10) Pub. No.: US 2026/0363257 A1
(43) Pub. Date: Nov. 19, 2026

(54) FOOD PROCESSING SYSTEM

(71) Applicant: Smithfield Foods, Inc., Smithfield, VA (US)

(72) Inventors: Alfonso Narez Heredia, Sioux Falls, SD (US); Victor M. Hernandez, Sioux Falls, SD (US)

(73) Assignee: Smithfield Foods, Inc., Smithfield, VA (US)

(21) Appl. No.: 19/663,457

(22) Filed: Apr. 30, 2026

Related U.S. Application Data
(60) Provisional application No. 63/806,978, filed on May 16, 2025.

(51) Int. Cl. A23B 4/03; A22C 17/00

(52) U.S. Cl. CPC A23B 4/031; A22C 17/00

(57) ABSTRACT

An example tray assembly for a food processing system is provided. The tray assembly includes a bottom tray configured to receive and support a food product thereon, and at least one top tray positioned over and pivotably movable relative to the bottom tray. The at least one top tray defines a proximal edge and a distal edge opposing the proximal edge. The distal edge of the at least one top tray is vertically offset from the bottom tray and defines a hinge mechanism along which the at least one top tray pivots relative to the bottom tray. The at least one top tray is movable into an open position at which the top tray is pivoted away from the bottom tray to expose a space between the at least one top tray and the bottom tray for positioning of the food product on the bottom tray.

### BACKGROUND

This application claims the benefit of a co-pending, commonly assigned U.S. Provisional Patent Application No. 63/806,978, which was filed on May 16, 2025, the foregoing application is incorporated herein by reference in its entirety.

### BACKGROUND

In the meat processing and/or curing industry, a tree or rack structure is typically used to suspend ham, bacon, lunchmeat, or the like, during multiple steps of the curing or cooking process. For example, FIG. 1 shows a perspective view of a traditional food processing tree system 10 used in the industry. The system 10 includes a central support rod 12 which is oriented substantially vertically relative to the floor 14. The support rod 12 can be releasably coupled to an overhead suspension system (not shown) to maintain the entire system 10 suspended over the floor 14.

The system 10 includes multiple laterally oriented support platforms 16 secured to the support rod 12. The support platforms 16 extend laterally outward from the support rod 12, and are vertically offset or spaced from each other to accommodate positioning of a food product, e.g., ham, bacon, lunchmeat, or the like, therebetween. Each of the support platforms 16 defines a top surface and an opposing bottom surface. In some embodiments, the top surface of the support platforms 16 can include parallel grooves 18 formed therein, which can assist with maintaining racks or trays thereon.

The system 10 includes a tray assembly positionable on each of the support platforms 16. The tray assembly includes a bottom tray 20 and a top tray 22, e.g., grates, racks, or the like. In use, the bottom tray 20 is positioned on the top surface of the support platform 16, the food product 24 is positioned on the bottom tray 20, and the top tray 22 is positioned over the food product 24, thereby sandwiching the food product 24 between the bottom and top trays 20, 22. Springs 26 are used to secure the bottom and top trays 20, 22 to each other, and over the food product 24.

During the loading process, because the bottom tray 20 is loosely positioned on the support platform 16 and the top tray 22 is loosely positioned over the food product 24, balancing and securing the bottom and top trays 20, 22 relative to each other with the springs 26 may be difficult. The top tray 22 may pivot on the food product 24, resulting in springs 26 detaching and/or falling from the system 10. When not in use, the bottom and top trays 20, 22 are generally loosely positioned on the support platforms 16, which can result in trays 20, 22 inadvertently falling onto the floor 14. This can result in a safety issue for individuals using the system 10, and can damage components of the system 10.

### SUMMARY

Embodiments of the present disclosure provide a food processing system that includes a tray assembly including a fixed bottom tray and a top tray hingedly coupled to the system. The hinged configuration of the top tray provides a convenient structure for loading food product onto the system, positioning the top tray over the food product, and coupling the top and bottom trays relative to each other. Due to the movable connection of the top tray to the system, the top tray remains balanced over the food product while the individual couples the top and bottom trays to each other. The hinged connection of the top tray ensures substantially uniform pressure is applied to the food products in the system. The tray assembly allows for the bottom and top trays to remain attached to the system when not in use, thereby avoiding any safety issues typically encountered in traditional systems. The complexity of loading and unloading food product on the exemplary system is thereby significantly reduced.

In accordance with embodiments of the present disclosure, an exemplary tray assembly for a food processing system is provided. The tray assembly includes a bottom tray configured to receive and support a food product thereon, and at least one top tray positioned over and pivotably movable relative to the bottom tray. The at least one top tray defines a proximal edge and a distal edge opposing the proximal edge. The distal edge of the at least one top tray is vertically offset from the bottom tray and defines a hinge mechanism along which the at least one top tray pivots relative to the bottom tray. The at least one top tray is movable into an open position at which the proximal edge of the at least one top tray is pivoted away from the bottom tray to expose a space between the at least one top tray and the bottom tray for positioning of the food product between the bottom tray and the at least one top tray.

The tray assembly can include a first support extending perpendicularly from a first side edge of the bottom tray and a second support extending perpendicularly from a second side edge of the bottom tray. The first side edge opposes the second side edge. The distal edge of the at least one top tray can be hingedly coupled to the first and second supports for pivoting of the at least one top tray relative to the bottom tray. The at least one top tray is not detachable relative to the bottom tray. The bottom tray can include a raised edge along a perimeter of the bottom tray. The raised edge extends above a top surface of the bottom tray along the perimeter. The raised edge can prevent inadvertent sliding of the food product off the bottom tray.

In some embodiments, the at least one top tray can include a first top tray and a second top tray. The first top tray and the second top tray can be pivotably mounted to the bottom tray in opposing directions. The distal edge of the first top tray can be disposed adjacent to and spaced by a gap from the distal edge of the second top tray. The proximal edge of the first top tray can be disposed adjacent to a front edge of the bottom tray and the proximal edge of the second top tray can be disposed adjacent to a rear edge of the bottom tray, the front edge opposing the rear edge. The tray assembly can include at least one fastening element configured to detachably secure the at least one top tray to the bottom tray to at least partially compress and retain the food product between at least one top tray and the bottom tray. In some embodiments, the bottom tray and the at least one top tray can define a grated structure.

In accordance with embodiments of the present disclosure, an exemplary food processing system is provided. The system includes a support rod, and at least one tray assembly coupled to the support rod. The at least one tray assembly includes a bottom tray configured to receive and support a food product thereon, and at least one top tray positioned over and pivotably movable relative to the bottom tray. The at least one top tray defines a proximal edge and a distal edge opposing the proximal edge. The distal edge of the at least one top tray is vertically offset from the bottom tray and defines a hinge mechanism along which the at least one top tray pivots relative to the bottom tray. The at least one top tray is movable into an open position at which the proximal edge of the at least one top tray is pivoted away from the bottom tray to expose a space between the at least one top tray and the bottom tray for positioning of the food product between the bottom tray and the at least one top tray.

A position of the at least one tray assembly can be movable along the support rod. The at least one tray assembly can include a first support extending perpendicularly from a first side edge of the bottom tray and a second support extending perpendicularly from a second side edge of the bottom tray. The first side edge opposes the second side edge. The distal edge of the at least one top tray is hingedly coupled to the first and second supports for pivoting of the at least one top tray relative to the bottom tray.

In some embodiments, the bottom tray can include a raised edge along a perimeter of the bottom tray. The raised edge extends above a top surface of the bottom tray along the perimeter. The at least one top tray can include a first top tray and a second top tray pivotably mounted to the bottom tray in opposing directions. The distal edge of the first top tray can be disposed adjacent to and spaced by a gap from the distal edge of the second top tray. The proximal edge of the first top tray can be disposed adjacent to a front edge of the bottom tray and the proximal edge of the second top tray can be disposed adjacent to a rear edge of the bottom tray. The front edge opposes the rear edge.

In accordance with embodiments of the present disclosure, an exemplary method of food product processing is provide. The method includes moving at least one top tray of a tray assembly of a food processing system into an open position by pivoting a proximal edge of the at least one top tray away from a bottom tray of the tray assembly to expose as pace between the at least one top tray and the bottom tray. The method includes positioning a food product on the bottom tray such that the food product is positioning between the bottom tray and the at least one top tray. The method includes pivoting the at least one top tray towards the bottom tray and against the food product to at least partially compress and retain the position of the food product between the at least one top tray and the bottom tray. The method includes detachably securing the at least one top tray to the bottom tray with a fastening element. The at least one top tray is positioned over and pivotably movable relative to the bottom tray. The at least one top tray defines the proximal edge and a distal edge opposing the proximal edge. The distal edge of the at least one top tray is vertically offset from the bottom tray and defines a hinge mechanism along which the at least one top tray pivots relative to the bottom tray.

Any combination and/or permutation of embodiments is envisioned. Other objects and features will become apparent from the following detailed description considered in conjunction with the accompanying drawings. It is to be understood, however, that the drawings are designed as an illustration only and not as a definition of the limits of the present disclosure.

### BRIEF DESCRIPTION OF THE DRAWINGS

To assist those of skill in the art in making and using the food processing system, reference is made to the accompanying figures, wherein:

FIG. 1 is a perspective view of a traditional food processing tree system.

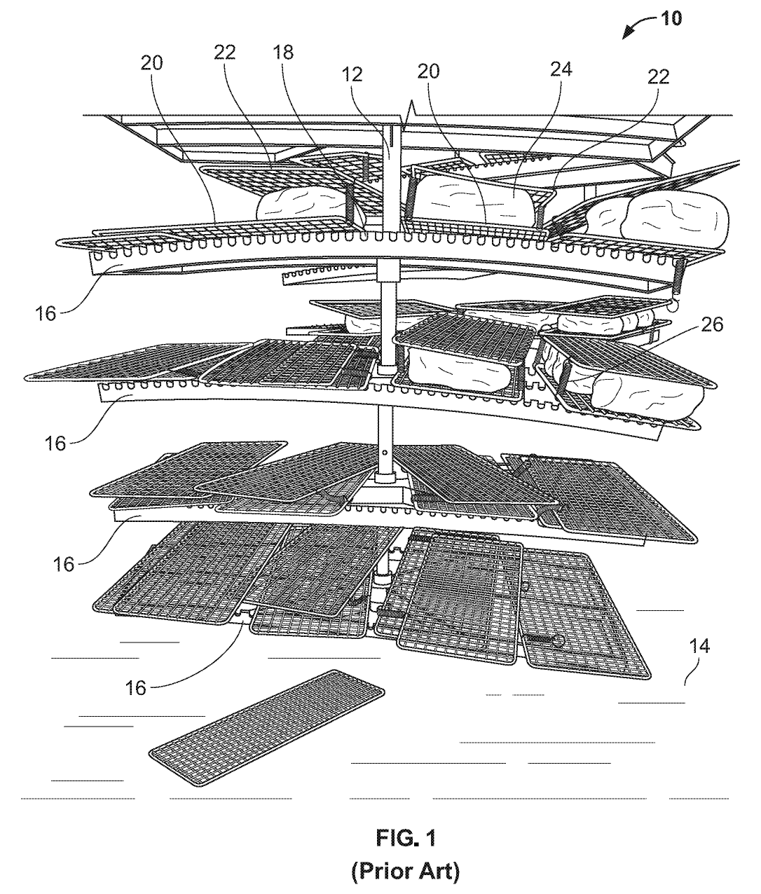

FIG. 2 is a perspective view of an exemplary food processing system in accordance with embodiments of the present disclosure.

FIG. 3 is a detailed view of an exemplary food processing system of FIG. 2, including top trays movable at hinges.

FIG. 4 is a detailed view of an exemplary food processing system of FIG. 2, including springs for coupling top and bottom trays to each other.

FIG. 5 is a detailed view of an exemplary food processing system of FIG. 2, including springs maintaining a top tray separated from a bottom tray for loading of food product onto the bottom tray.

FIG. 6 is a perspective view of an exemplary food processing system of FIG. 2, including food product loaded onto a bottom tray.

### DETAILED DESCRIPTION

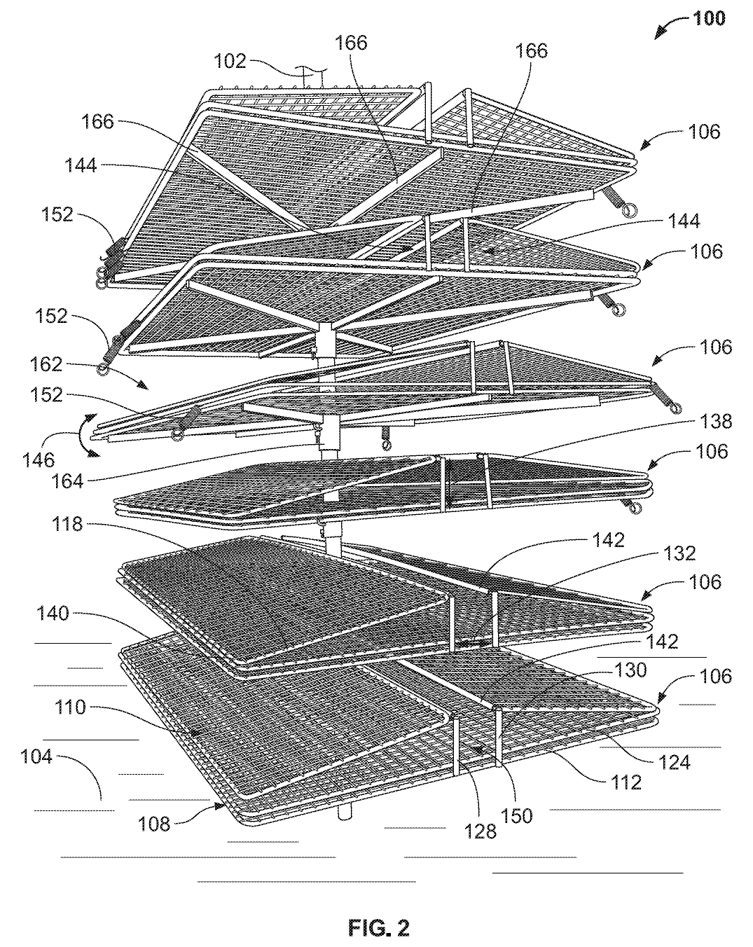

FIGS. 2-6 are perspective and detailed views of an exemplary food processing system 100 (hereinafter “system 100”). Although discussed herein as a tree support, it should be understood that the system 100 can be used to provide suspension and support for any type of rack configuration. The system 100 includes a support rod 102 oriented vertically and configured to be releasably coupled with a suspension assembly such that the system 100 is suspended over the floor 104. The system 100 includes one or more tray assemblies 106 movably coupled to the support rod 102. The tray assemblies 106 are vertically spaced from each other along the support rod 102, and define separate “tiers” along the support rod 102.

Each tray assembly 106 includes a bottom tray 108 and a top tray 110. In some embodiments, each tray assembly 106 can include a single bottom tray 108 and two top trays 110 extending in opposite directions relative to each other, e.g., away from the support rod 102. In such embodiments, the bottom tray 108 spans the around and on both sides of the support rod 102, and the respective top trays 110 extend away from the support rod 102 on opposing sides. In some embodiments, the bottom tray 108 can be about, e.g., 39 inches in width and 54 inches in length, and the top trays 110 can each be about, e.g., 16 inches in width and 54 inches in length, with about a 4 inch gap between the respective top trays 110. However, the dimensions of the trays 108, 110 are provided for example only and are not limited to these values.

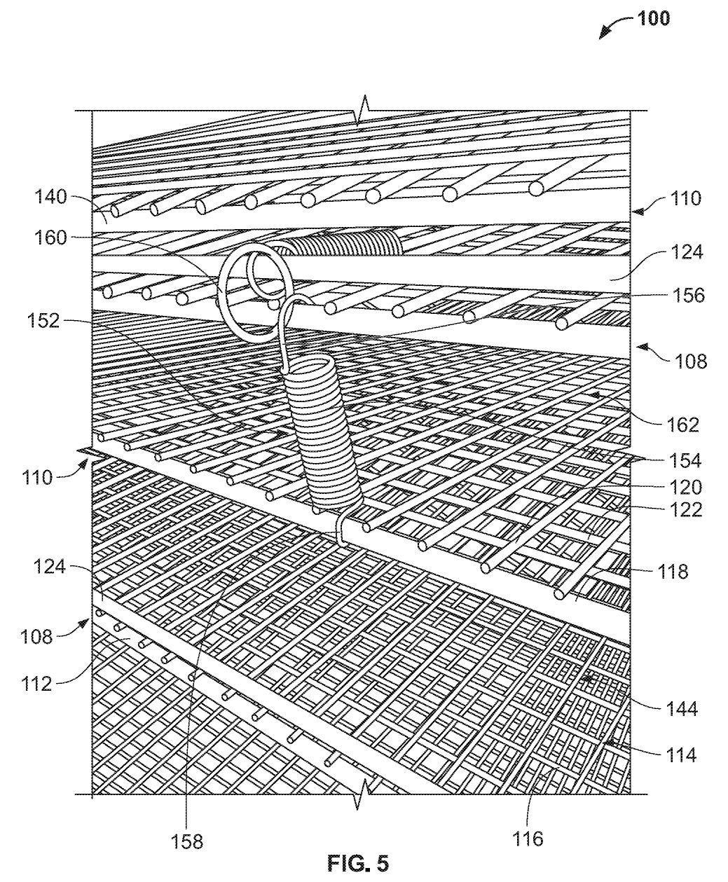

In some embodiments, the bottom and top trays 108, 110 can be formed from metal, e.g., 304 stainless steel, or the like. In some embodiment, the entire system 100 (or the majority of the system 100) can be formed from the metal material. In some embodiments, each of the bottom and top trays 108, 110 can define a grated structure. For example, the bottom tray 108 can include a perimeter edge 112 defining a solid structure (e.g., a bar, or the like) that extends along the entire perimeter of the bottom tray 108. Within the interior of the perimeter edge 112, the bottom tray 108 includes a grated structure formed by crisscrossing thin, elongated bars 114, 116 defining a plurality of square openings. (See, e.g., FIG. 5). In some embodiments, the openings between the bars 114, 116 can be about, e.g., 1 inch x 1 inch, or the like. The top trays 110 can similarly include a perimeter edge 118 defining a solid structure that extends along the entire perimeter of the top tray 110. Within the interior of the perimeter edge 118, the top tray 110 includes a grated structure with crisscrossing thin, elongated bars 120, 122 defining a plurality of square openings, e.g., about 1 inch x 1 inch openings, or the like. (see, e.g., FIG. 5). The grated structure of the bottom and top trays 108, 110 is therefore substantially similar.

Each of the bottom and top trays 108, 110 defines a substantially planar or flat structure, with the bottom tray 108 configured to receive and support a food product thereon, and the top tray 110 configured to be positioned at least partially over the food product to “sandwich” the food product between the bottom and top trays 108, 110. In some embodiments, the bottom tray 108 can include a raised lip or edge 124. The raised edge 124 can define a structure substantially similar to the perimeter edge 112. The raised edge 124 defines a solid structure (e.g., a bar, or the like) dimensioned substantially equally in thickness/diameter as the perimeter edge 112, and overall size. The raised edge 124 is therefore vertically offset directly over the perimeter edge 112 by spacers 126 that secure the raised edge 124 to the perimeter edge 112 along the perimeter of the bottom tray 108. The raised edge 124 can define an approximately 1 inch border around the perimeter of the bottom tray 108, which can assist with maintaining the food product safely on the bottom tray 108 during loading.

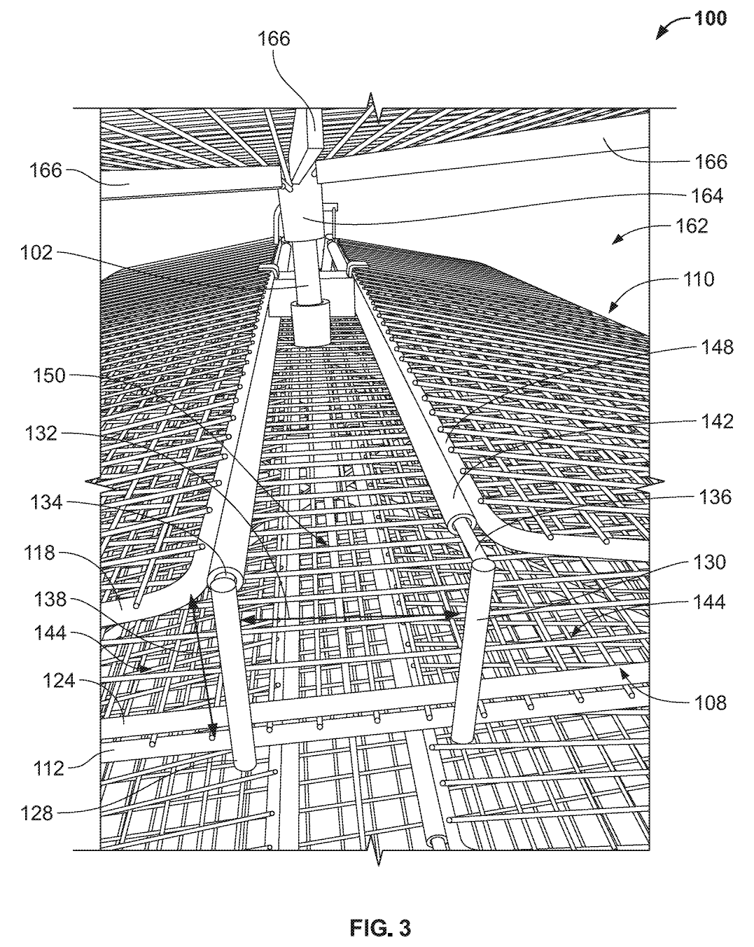

Each bottom tray 108 includes a pair of offset supports 128, 130 extending substantially perpendicularly from the perimeter edge 112 on opposing sides of the bottom tray 108 (e.g., side edges of the bottom tray 108). The offset supports 128, 130 can be in the form of, e.g., bars, flanges, or the like, having a substantially similar thickness and/or cross-section as the perimeter edge 112. The offset supports 128, 130 come in pairs on opposing sides of the bottom tray 108 to support the respective top trays 110. Although only one side of the bottom tray 108 is visible in FIGS. 2 and 3, it should be understood that the opposing side of the bottom tray 108 includes similar offset supports 128, 130.

The offset supports 128, 130 are positioned near a midpoint of the side edge of the bottom tray 108, but are spaced from each other by a distance 132. In some embodiments, the distance 132 can be about, e.g., 4 inches, or the like. As best seen in FIG. 3, the distance 132 between the offset supports 128, 130 creates a central gap or passage 150 between the top trays 110 which provides clearance around the support rod 102 passing through the center of the bottom tray 108. The pairs of offset supports 128, 130 are connected to each other by hinge rods 134, 136 which extend over the entire length of the bottom tray 108. In some embodiments, hinge rods 134, 136 can extend perpendicularly from the top ends of the offset supports 128, 130 and only extend a partial distance towards each other over the bottom trap 108, e.g., not the full length of the bottom tray 108. In some embodiments, the length of the offset supports 128, 130 can be about, e.g., 4 inches, which creates an approximately 4 inch vertically offset distance 138 between the bottom tray 108 and the top tray 110.

One edge along the length of the top tray 110 can define a distal edge 148, and the opposing parallel edge of the top tray 110 can define a proximal edge 140 (e.g., rear and front edges). The proximal and distal edges 140, 148 extend perpendicularly and connect the side edges of the top tray 110, thereby defining a substantially rectangular configuration. The bottom tray 108 similarly defines a substantially rectangular configuration dimensioned greater than the top tray 110. The distal edge 148 of the top trays 110 includes a hollow tube 142 secured thereto or extending therefrom parallel to the distal edge 148. The hollow tube 142 is dimensioned complementary to the hinge rods 134, 136 of the offset supports 128, 130. In particular, the hollow tube 142 at least partially receives a hinge rod 134, 136 therein to form a hinge mechanism at the distal edge 148 of the top tray 110. The hinge mechanism allows the top tray 110 to be selectively pivoted away from and towards the bottom tray 108 without detachment of the top tray 110 from the bottom tray 108. The hinge mechanism (and the distal edge 148 of the top tray 110) is therefore disposed adjacent to the support rod 102, and extends substantially the entire length of the top tray 110 and the bottom tray 108. The full length of the hinge mechanism ensures that substantially uniform pressure is applied to the food product positioned between the bottom tray 108 and the top tray 110.

The top tray 110 is dimensioned such that when the bottom tray 108 is not supporting a food product, the proximal edge 140 of the top tray 110 can be pivoted downward to rest on top of the raised edge 124 of the bottom tray 108. The top tray 110 can remain in this position due to gravity, or in some embodiments can be coupled to the bottom tray 108 to maintain this position. The proximal edge 140 of the opposing top trays 110 defines the outermost edges on opposing sides of the tray assemblies 106. The opposing distal edge 148 of each top tray 110 (e.g., at the hinge mechanism) remains vertically offset from the bottom tray 108 by the distance 138, resulting in a continuous space or gap 144 between the distal edge 148 of the top tray 110 and the bottom tray 108. This offset distance at the distal edge 148 of the top tray 110 remains constant along the length of the top tray 110, while the proximal edge 140 can be pivoted away from and towards the bottom tray 108 along radial direction 146. The gap 144 accommodates placement of food product on the bottom tray 108 when the top tray 110 is pivoted away from the bottom tray 108.

The system 100 can include multiple fastening elements 152, e.g., springs, or the like, for detachably securing the bottom and top trays 108, 110 to each other. In some embodiments, at each side of the tray assemblies 106 where the proximal edge 140 of the top tray 110 meets the raised edge 124 of the bottom tray 108, the tray assembly 106 can include three fastening elements 152. For example, one fastening element 152 can be located at or near each of the corners of the tray assembly 106, and one fastening element 152 can be centrally located between the corners to allow for selective engagement with the proximal edge of the bottom tray 108 (and/or the raised edge 124) and the proximal edge 140 of the top tray 110.

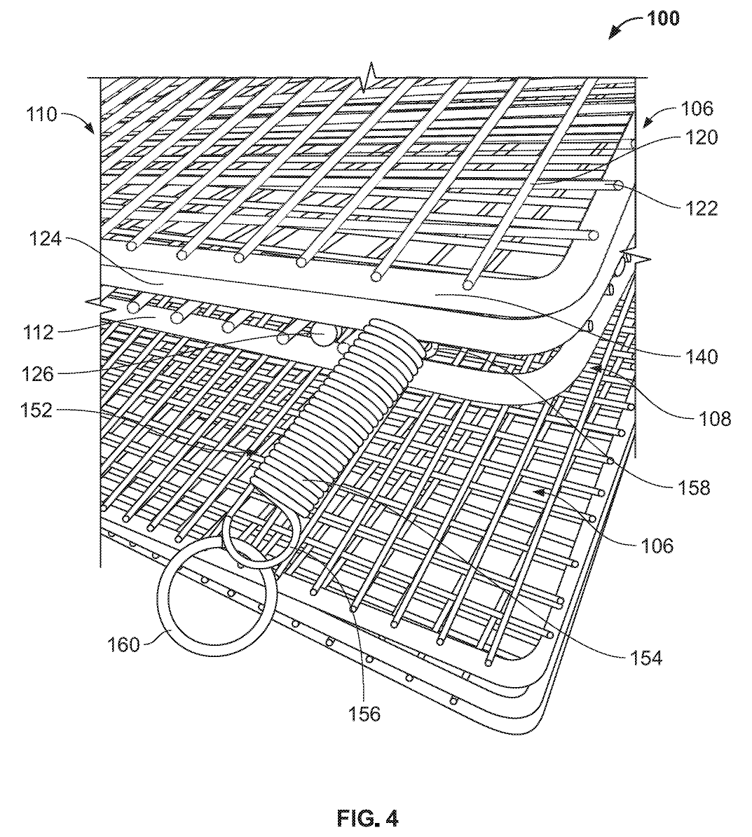

Each fastening element 152 can include an expandable or stretchable body 154, and opposing ends 156, 158 including engagement structures (e.g., hooks, or the like) capable of being engaged with the structures associated with the bottom and top trays 108, 110. (See, e.g., FIG. 4). For example, the ends 156, 158 can include a hook or curved shape capable of being at least partially wrapped around the perimeter edge 112, 118 of the respective bottom and top trays 108, 110. In some embodiments, both ends 156, 158 of the fastening element 152 can be detachable from the bottom and top trays 108, 110.

In some embodiments, one of the ends 156, 158 can be non-detachably secured to either the bottom or top tray 108, 110. For example, the end 158 in FIG. 4 can be non-detachably secured to the bottom tray 108, and the end 156 can be detachably or releasably secured to the top tray 110 after food product has been positioned on the bottom tray 108. Such fixed positioning of one end of the fastening element 152 prevents loss of the fastening elements 152 during use of the system 100. In some embodiments, the detachable end 156 can include a gripping structure 160 (e.g., a ring, or the like) secured to the end 156. The gripping structure 160 can provide means for gripping and pulling on the fastening element 152 to stretch the body 154 and engage the end 156 with the top tray 110. When the ends 156, 158 of the fastening element 152 are engaged with the bottom and top trays 108, 110, the fastening element 152 biases the trays 108, 110 towards each other to at least partially compress and retain the food product between the trays 108, 110.

In some embodiments, the non-detachably connection of the fastening element 152 can alternate along the edge of the tray assembly 106. In some embodiments, the centrally disposed fastening element 152 can be non-detachably connected to the top tray 110 such that during loading of food product on the bottom tray 108, the top tray 110 can be pivoted upwards away from the associated bottom tray 108 and detachably secured with the fastening element 152 to the bottom tray 108 of the tray assembly 106 above. This provides clearance at the proximal edge 140 and into the space or gap 144 between the bottom and top trays 108, 110 for loading of food product onto the bottom tray 108. After loading of the food product is complete, the fastening element 152 can be disengaged from the bottom tray 108 of the adjacent tray assembly 106, and the same fastening element 152 can be used to secure the top tray 110 to the bottom tray 108 supporting the food product. In such embodiments, the fastening elements 152 located at or near the corners of the tray assembly 106 can be non-detachably connected to the bottom tray 108 and, after loading of the food product onto the bottom tray 108, the fastening elements 152 can be secured to the top tray 110 associated with the tray assembly 106. In some embodiments, all fastening elements 152 can be non-detachably connected to the top tray 110 of each tray assembly 106.

In some embodiments, the position of each of the tray assemblies 106 along the support rod 102 can be adjusted. For example, the position of the tray assemblies 106 along the support rod 102 can be adjusted to add or reduce the number of tray assemblies 106 being used, or to vary a vertical spacing 162 between the tray assemblies 106 (e.g., the distance between the top tray 110 of one tray assembly 106 and the bottom tray 108 of the adjacent tray assembly 106).

The adjustment mechanism can include a coupler 164 secured to the bottom surface of the bottom tray 108, and support flanges 166 extending outwardly from the coupler 164 and at least partially under the bottom tray 108 to support the underside of the bottom tray 108. He coupler 164 can be in the form of a cylindrical tube with a central opening. In particular, the coupler 164 includes an opening complementary to the support rod 102 such that the support rod 102 can be slidably passed through the coupler 164. The position of the coupler 164 can be secured relative to the support rod 102 with, e.g., one or more set screws, pins, or the like. For example, the support rod 102 can include an array of through holes and the coupler 164 can include a complementary set of through holes such that the through holes of the coupler 164 can be aligned with the through holes of the support rod 102 at the desired position, and a pin can be passed through the aligned through holes to maintain the position of the coupler 164 relative to the support rod 102. The desired vertical position of the tray assembly 106 can therefore be selected by sliding the tray assembly 106 along the support rod 102, and tightening or otherwise engaging the coupler 164 with the support rod 102. The flanges 166 support the underside of the bottom tray 108 of the tray assembly 108, which indirectly supports the top tray 110 as well. Customization of the tray assembly 106 positioning and number can therefore be achieved. In some embodiments, the distance from the bottom tray 108 of the lowest tier or tray assembly 106 to the bottom tray 108 of the highest tier or tray assembly 106 can be about, e.g., 46 inches, or the like. In some embodiments, the distance between the bottom trays 108 of the adjacent tray assemblies 106 can be about, e.g., 9 inches, or the like.

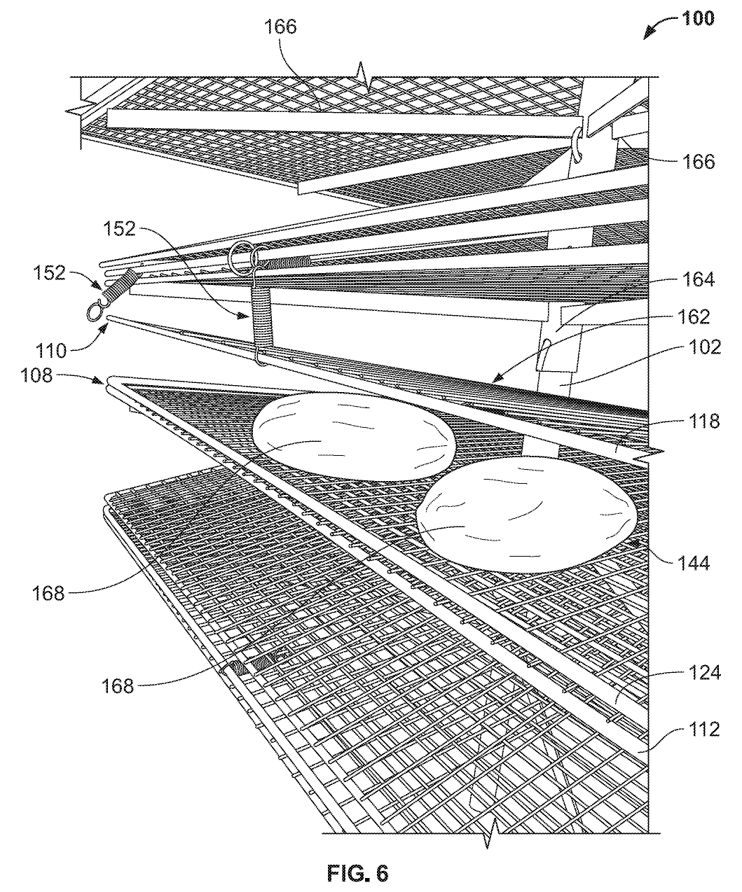

In use, the bottom and top trays 108, 110 remain secured to the system 100 when the tray assemblies 106 are not in use. Thus, separation of the trays 108, 110 from the system 100 cannot inadvertently occur. When loading of a food product 168 is desired, the top tray 110 is pivoted upwards and away from the bottom tray 108 of the respective tray assembly 106. (See, e.g., FIG. 6). In some embodiments, the top tray 110 can be detachably secured to the bottom tray 108 of the next adjacent tray assembly 106 with a fastening element 152 to maintain clearance for insertion of the food product 168 onto the bottom tray 108. In some embodiments, each tray assembly 106 can support 5-6 food products 168 on each side (e.g., under each top tray 110), or 10-12 food products 168 on the entire tray assembly 106. After loading of the food products 168 is complete, the top tray 110 can be lowered onto the food products 168 and the fastening elements 152 are used to secure the bottom and top trays 108, 110 to each other, thereby securing the food products 168 in the tray assembly 106. The system 100 can thereby be used to secure food products 168 without the risk of falling tray components, ensuring a safe and convenient operation.

While exemplary embodiments have been described herein, it is expressly noted that these embodiments should not be construed as limiting, but rather that additions and modifications to what is expressly described herein also are included within the scope of the invention. Moreover, it is to be understood that the features of the various embodiments described herein are not mutually exclusive and can exist in various combinations and permutations, even if such combinations or permutations are not made express herein, without departing from the spirit and scope of the invention.

1. A tray assembly for a food processing system, the tray assembly comprising:
a bottom tray configured to receive and support a food product thereon;
at least one top tray positioned over and pivotably movable relative to the bottom tray;
wherein the at least one top tray defines a proximal edge and a distal edge opposing the proximal edge;
wherein the distal edge of the at least one top tray is vertically offset from the bottom tray and defines a hinge mechanism along which the at least one top tray pivots relative to the bottom tray; and
wherein the at least one top tray is movable into an open position at which the proximal edge of the at least one top tray is pivoted away from the bottom tray to expose a space between the at least one top tray and the bottom tray for positioning of the food product between the bottom tray and the at least one top tray.

2. The tray assembly of claim 1, comprising a first support extending perpendicularly from a first side edge of the bottom tray and a second support extending perpendicularly from a second side edge of the bottom tray, the first side edge opposing the second side edge.

3. The tray assembly of claim 2, wherein the distal edge of the at least one top tray is hingedly coupled to the first and second supports for pivoting of the at least one top tray relative to the bottom tray.

4. The tray assembly of claim 1, wherein the at least one top tray is not detachable relative to the bottom tray.

5. The tray assembly of claim 1, wherein the bottom tray comprises a raised edge along a perimeter of the bottom tray, the raised edge extending above a top surface of the bottom tray along the perimeter.

6. The tray assembly of claim 5, wherein the raised edge prevents inadvertent sliding of the food product off the bottom tray.

7. The tray assembly of claim 1, wherein the at least one top tray comprises a first top tray and a second top tray.

8. The tray assembly of claim 7, wherein the first top tray and the second top tray are pivotably mounted to the bottom tray in opposing directions.

9. The tray assembly of claim 8, wherein the distal edge of the first top tray is disposed adjacent to and spaced by a gap from the distal edge of the second top tray.

10. The tray assembly of claim 8, wherein the proximal edge of the first top tray is disposed adjacent to a front edge of the bottom tray and the proximal edge of the second top tray is disposed adjacent to a rear edge of the bottom tray, the front edge opposing the rear edge.

11. The tray assembly of claim 1, comprising at least one fastening element configured to detachably secure the at least one top tray to the bottom tray to at least partially compress and retain the food product between at least one top tray and the bottom tray.

12. The tray assembly of claim 1, wherein the bottom tray and the at least one top tray define a grated structure.

13. A food processing system, comprising:
a support rod;
at least one tray assembly coupled to the support rod, the at least one tray assembly comprising:
a bottom tray configured to receive and support a food product thereon;
at least one top tray positioned over and pivotably movable relative to the bottom tray;
wherein the at least one top tray defines a proximal edge and a distal edge opposing the proximal edge;
wherein the distal edge of the at least one top tray is vertically offset from the bottom tray and defines a hinge mechanism along which the at least one top tray pivots relative to the bottom tray; and
wherein the at least one top tray is movable into an open position at which the proximal edge of the at least one top tray is pivoted away from the bottom tray to expose a space between the at least one top tray and the bottom tray for positioning of the food product between the bottom tray and the at least one top tray.

14. The food processing system of claim 13, wherein a position of the at least one tray assembly is movable along the support rod.

15. The food processing system of claim 13, wherein the at least one tray assembly comprises a first support extending perpendicularly from a first side edge of the bottom tray and a second support extending perpendicularly from a second side edge of the bottom tray, the first side edge opposing the second side edge.

16. The food processing system of claim 15, wherein the distal edge of the at least one top tray is hingedly coupled to the first and second supports for pivoting of the at least one top tray relative to the bottom tray.

17. The food processing system of claim 13, wherein the bottom tray comprises a raised edge along a perimeter of the bottom tray, the raised edge extending above a top surface of the bottom tray along the perimeter.

18. The food processing system of claim 13, wherein the at least one top tray comprises a first top tray and a second top tray pivotably mounted to the bottom tray in opposing directions.

19. The food processing system of claim 18, wherein the distal edge of the first top tray is disposed adjacent to and spaced by a gap from the distal edge of the second top tray, and wherein the proximal edge of the first top tray is disposed adjacent to a front edge of the bottom tray and the proximal edge of the second top tray is disposed adjacent to a rear edge of the bottom tray, the front edge opposing the rear edge.

20. A method of food product processing, the method comprising:
moving at least one top tray of a tray assembly of a food processing system into an open position by pivoting a proximal edge of the at least one top tray away from a bottom tray of the tray assembly to expose as pace between the at least one top tray and the bottom tray;
positioning a food product on the bottom tray such that the food product is positioning between the bottom tray and the at least one top tray;
pivoting the at least one top tray towards the bottom tray and against the food product to at least partially compress and retain the position of the food product between the at least one top tray and the bottom tray; and
detachably securing the at least one top tray to the bottom tray with a fastening element;
wherein the at least one top tray is positioned over and pivotably movable relative to the bottom tray;
wherein the at least one top tray defines the proximal edge and a distal edge opposing the proximal edge; and
wherein the distal edge of the at least one top tray is vertically offset from the bottom tray and defines a hinge mechanism along which the at least one top tray pivots relative to the bottom tray.
